(19) United States
(12) Patent Application Publication
(10) Pub. No.: US 2010/0034493 A1
(43) Pub. Date: Feb. 11, 2010

(54) Fluid bearing device

(76) Inventors: Masaharu Hori, Mie (JP); Tetsuya Kurimura, Mie (JP)

Correspondence Address: WENDEROTH, LIND & PONACK, L.L.P., 1030 15th Street, N.W.,, Suite 400 East, Washington, DC, 20005-1503, US

(21) Appl. No.: 11/989,597

(22) PCT Filed: Jun. 2, 2006
(86) PCT No.: PCT/JP2006/311078

§ 371 Date: Jul. 22, 2009

(30) Foreign Application Priority Data
Aug. 31, 2005 (JP) 2005-252246

(51) Int. Cl. F16C 32/06

(52) U.S. Cl. 384/114

(57) ABSTRACT

Provided is a fluid bearing device in which run-out of another member fixed to a shaft member is suppressed. At one end of a shaft member (2), there is provided a press-fitting fixation surface (2a4) to which a hub (3) can be press-fitted and fixed. Further, between the press-fitting fixation surface (2a4) and an end surface (2d), there is provided a guide portion (10) to be used when press-fitting the hub (3) onto the press-fitting fixation surface (2a4). The guide portion (10) is provided with a cylindrical surface (11) of a smaller diameter than an inner peripheral surface (3b) of the hub (3). Further, between the press-fitting fixation surface (2a4) and the cylindrical surface (11), there is provided a first diverging surface (12) with an arcuate section gradually diverging from the cylindrical surface (11) toward the press-fitting fixation surface (2a4), and between the cylindrical surface (11) and the end surface (2d), there is provided a tapered second diverging surface (13) gradually diverging from the end surface (2d) toward the cylindrical surface (11).

### BACKGROUND OF THE INVENTION

1. Field of the Invention

The present invention relates to a fluid bearing device that supports a shaft member in a manner which allows relative rotation by a lubricating film of a fluid generated in a bearing gap. This bearing device is suitably used, for example, as a bearing device for a small motor, for example, a spindle motor for an information apparatus, for example, a magnetic disc drive device, such as an HDD, an optical disc drive device, such as a CD-ROM, a CD-R/RW, or a DVD-ROM/RAM, or a magneto-optical disc drive device, such as an MD or an MO, a polygon scanner motor for a laser beam printer (LBP), a color wheel motor for a projector, or a fan motor.

2. Description of the Related Art

The various types of motors mentioned above are required to have, apart from high rotational precision, an increased speed, reduced cost, reduced noise, etc. One of the factors determining those required performance characteristics is a bearing supporting a spindle of the motor. In recent years, use of a fluid bearing superior in the above-mentioned performance characteristics is being considered, or already actually practiced.

Fluid bearings of this type are roughly classified into dynamic pressure bearings equipped with a dynamic pressure generating portion for generating a dynamic pressure generating effect in a lubricating fluid in a bearing gap, and so-called cylindrical bearings (bearings with a perfectly circular sectional configuration) that are equipped with no dynamic pressure generating portion.

For example, in a fluid bearing device to be incorporated into a spindle motor for a disc drive device, such as an HDD, a radial bearing portion supporting a shaft member in a radial direction and a thrust bearing portion supporting the shaft member in a thrust direction may be both formed by dynamic pressure bearings. As the radial bearing portion of a fluid bearing device (dynamic pressure bearing device) of this type, there is known, for example, a radial bearing portion in which dynamic pressure grooves as dynamic pressure generating portions are formed on either an inner peripheral surface of the bearing sleeve or an outer peripheral surface of the shaft member opposed thereto and in which a radial bearing gap is formed between the two surfaces (see, for example, JP 2003-239951 A).

When incorporating a fluid bearing device of this type into the spindle motor for a magnetic disk device, such as an HDD, a hub for retaining a disk serving as an information storage medium is press-fitted and fixed to a forward end of a shaft member, thereby making it possible for the disk to rotate integrally with the shaft member. When, in this process, a hub is press-fitted in a state in which it is inclined with respect to the shaft member, run-out of the hub or of the disk retained by the hub increases, which may adversely affect the disk reading accuracy, etc.

### SUMMARY OF THE INVENTION

It is an object of the present invention to provide a fluid bearing device in which run-out of another member fixed to a shaft member is suppressed.

To solve the above mentioned problem, the present invention provides a fluid bearing device including: a shaft member to which another member is press-fitted and fixed; a radial bearing gap formed between an outer peripheral surface of the shaft member and a surface opposed to the outer peripheral surface of the shaft member, a lubricant film of a fluid generated in the radial bearing gap supporting the shaft member in a manner which allows relative rotation; a press-fitting fixation surface formed at least one end of the shaft member; and a guide portion to be used when press-fitting the other member onto the press-fitting fixation surface provided between the press-fitting fixation surface and a shaft end surface, in which the guide portion has a cylindrical surface having a smaller diameter than an inner peripheral surface of the other member. Here, the press-fitting fixation can be effected by any fixing means as long as it allows fixation through press-fitting. For example, the fixing means includes means for performing press-fitting, with adhesive existing between two members to be fixed together through press-fitting.

The press-fitting of the other member onto the shaft member is usually effected by forcing the other member with a press-fitting force onto the shaft end portion nearer to a position where the fixation is to be effected (press-fitting fixation surface). In this regard, as stated above, there is provided between the press-fitting fixation surface and the shaft end surface a guide portion to be used when press-fitting the other member. Further, the guide portion is provided with a cylindrical surface whose diameter is smaller than that of an inner peripheral surface of the other member, whereby an attitude of the other member fitted from the shaft end surface side (forcing-in attitude of the other member with respect to the press-fitting fixation surface) is rectified, making it possible to effect the press-fitting, with the inner peripheral surface of the other member being coaxial with the press-fitting fixation surface. Thus, when, for example, the other member is a hub, it is possible to fix the hub to the shaft member, with the disk mounting surface exhibiting a satisfactory perpendicularity with respect to the shaft member. As a result, it is possible to suppress run-out of the disk. Further, the satisfactory perpendicularity is obtained when the other member is assembled to the shaft member, so there is no need to separately perform tilt correction or the like on the other member afterwards, thereby making it possible to simplify an operation process.

The guide portion may have, for example, between the press-fitting fixation surface and the cylindrical surface, a first diverging surface gradually diverging from the cylindrical surface side toward the press-fitting fixation surface side. In this construction, the press-fitting of the other member onto the press-fitting fixation surface is guided smoothly, so it is possible to reliably press-fit the other member while securing the high level of coaxiality as obtained by the coaxial guide function of the cylindrical surface.

Further, the guide portion may have, between the cylindrical surface and the shaft end surface, a second diverging surface gradually diverging from the shaft end surface side toward the cylindrical surface side. With this construction, the second diverging surface functions as a guide surface when guiding the other member onto the cylindrical surface, so it is possible to effect the fitting of the other member onto the cylindrical surface smoothly.

Of the guide surfaces provided in the guide portion, it is desirable at least for the press-fitting fixation surface and the cylindrical surface to be formed by grinding. In particular, by simultaneously grinding the press-fitting fixation surface and the cylindrical surface in the same grinding process, it is possible to simplify the machining process and to enhance the coaxiality of the cylindrical surface with respect to the press-fitting fixation surface, thereby making it possible to perform the press-fitting of the other member onto the press-fitting fixation surface more accurately and smoothly.

The other member to be press-fitted and fixed to one end of the shaft member may, for example, be a hub for retaining a disk. In this case, the hub is press-fitted and fixed to the shaft member while aligned with the shaft member, so axial run-out of the disk retained by the hub is suppressed, thereby making it possible to achieve an improvement in terms of the reading or writing performance of the disk.

Apart from the above-described construction, it is possible to form, for example, a fluid bearing device in which the other member (such as a hub) is press-fitted and fixed to one end of the shaft member and in which there is further provided a seal portion press-fitted and fixed to the other end of the shaft member. In this case, it is desirable for the above-mentioned guide portion to be also provided at the other end of the shaft member. With this construction, it is possible to enhance the accuracy with which the seal portion is assembled to the shaft member (e.g., perpendicularity) and to thereby improve the sealing function.

As described above, in accordance with the present invention, it is possible to provide a fluid bearing device in which run-out of the other member fixed to the shaft member is suppressed.

### BRIEF DESCRIPTION OF THE DRAWINGS

In the accompanying drawings:

FIG. 1 is a sectional view of a spindle motor into which a fluid bearing device according to a first embodiment of the present invention is incorporated;

FIG. 2 is a sectional view of the fluid bearing device;

FIG. 3 is an enlarged view of a press-fitting fixation surface of the shaft member and portions around the same;

FIG. 4 is an enlarged view of another mode of the press-fitting fixation surface of the shaft member and portions around the same; and

FIG. 5 is a sectional view of a fluid bearing device according to a second embodiment of the present invention.

### DESCRIPTION OF THE PREFERRED EMBODIMENTS

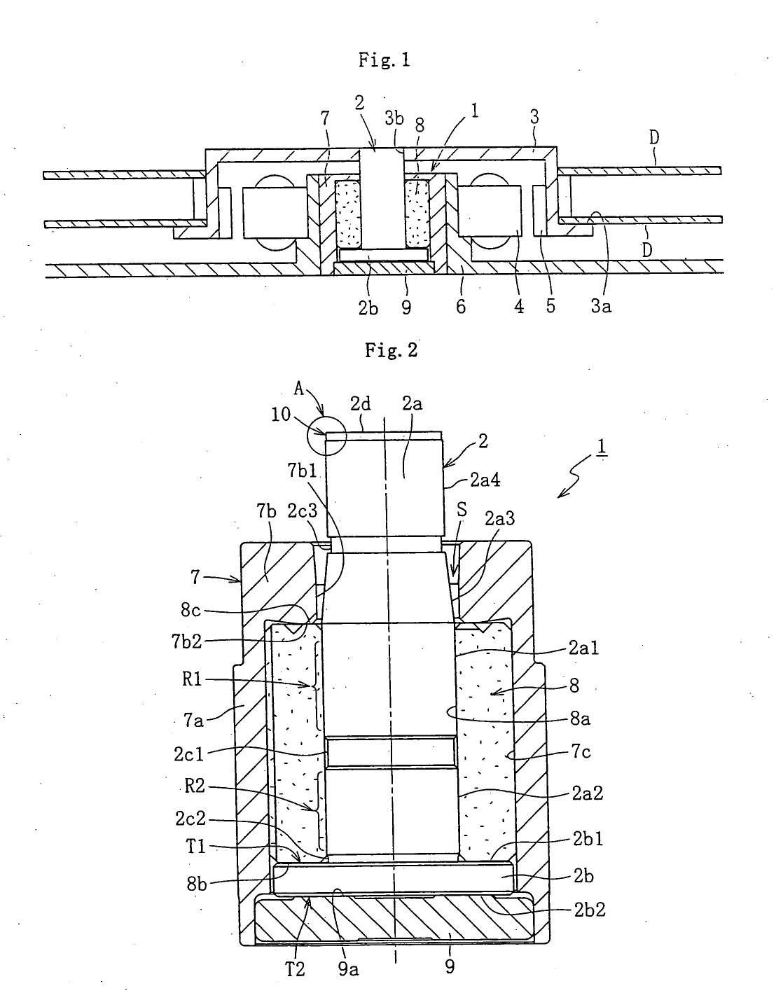

Hereinbelow, a first embodiment of the present invention will be described with reference to FIGS. 1 through 4.

FIG. 1 conceptually shows an example of a construction of a spindle motor for an information apparatus with a fluid bearing device (dynamic pressure bearing device) 1, according to the first embodiment of the present invention, incorporated therein. This spindle motor is used in a disc drive device, such as an HDD, and contains the dynamic pressure bearing device 1 supporting a shaft member 2 in a manner which allows relative rotation, a hub 3 mounted to the shaft member 2, a stator coil 4 and a rotor magnet 5 that are opposed to each other through the intermediation of, for example, a radial gap, and a bracket 6 as a motor base. The stator coil 4 is mounted to an outer periphery of the bracket 6, and the rotor magnet 5 is mounted to an inner periphery of the hub 3. The fluid bearing device 1 is fixed to the inner periphery of the bracket 6. The hub 3 retains one or a plurality of discs D as an information storage medium. In the spindle motor constructed as described above, when the stator coil 4 is energized, the rotor magnet 5 is rotated by a magnetic force generated between the stator coil 4 and the rotor magnet 5, whereby the hub 3 and the disk D retained by the hub 3 rotate integrally with the shaft member 2.

FIG. 2 shows the fluid bearing device 1. The fluid bearing device 1 is equipped with a housing portion 7, a sleeve portion 8 fixed to an inner periphery of the housing portion 7, a cover member 9 closing the housing portion 7, and the shaft member 2 adapted to make relative rotation with respect to the housing portion 7 and the sleeve portion 8. For convenience in illustration, of openings formed at both axial ends of the housing portion 7, the one closed by the cover member 9 will be referred to as a lower opening, and the one on the opposite side will be referred to as an upper opening.

The housing portion 7 is of a substantially cylindrical configuration, and is formed, for example, of a metal material, such as brass, or a resin composition whose base resin is a crystalline resin, such as LCP, PPS, or PEEK. In this embodiment, the housing portion 7 is formed so as to be open at both axial ends, and has, as integral parts, a cylindrical portion 7a and an annular seal portion 7b extending inwardly from the upper end of the cylindrical portion 7a. An inner peripheral surface 7b1 of the seal portion 7b forms, between itself and a tapered surface 2a3 provided in an outer periphery of the opposing shaft member 2, an annular seal space S whose radial dimension gradually diminishes upwards. In a state in which an interior of the fluid bearing device 1 is filled with lubricating oil, an oil level of the lubricating oil is always maintained within the seal space S.

The sleeve 8 is of a cylindrical configuration, and is formed, for example, of a metal material, such as a copper alloy like brass, or an aluminum alloy, or of a porous member composed of a sintered metal, such as copper. In this embodiment, the sleeve portion 8 is fixed to an inner peripheral surface 7c of the housing portion 7 by appropriate means, such as adhesion (inclusive of loose adhesion), press-fitting (inclusive of press-fitting adhesion), or welding (inclusive of ultrasonic welding), with an upper end surface 8c of the sleeve portion 8 being held in contact with a lower end surface 7b2 of the seal portion 7b.

All over an inner peripheral surface 8a of the sleeve 8 or in a part of the cylindrical region thereof, there is formed a region where a plurality of dynamic pressure grooves are arranged as radial dynamic pressure generating portions. Although not shown, in this embodiment, there are formed two axially separated regions where a plurality of dynamic pressure grooves are arranged in a herringbone-shaped configuration. These dynamic pressure groove formation regions are opposed to the outer peripheral surface (radial bearing surfaces 2a1 and 2a2) of the shaft member 2, and during rotation of the shaft member 2, form radial bearing gaps of a first radial bearing portion R1 and a second radial bearing portion R2 described below between themselves and the radial bearing surfaces 2a1 and 2a2 (see FIG. 2).

Although not shown, over an entire lower end surface 8b of the sleeve portion 8 or in a part of an annular region thereof, there is formed, for example, a region in which a plurality of dynamic pressure grooves are arranged in a spiral form. This dynamic pressure groove formation region is opposed, as a first thrust bearing surface, to an upper end surface 2b1 of a flange portion 2b, and during rotation of the shaft member 2, forms between itself and the upper end surface 2b1 a thrust bearing gap of a first thrust bearing portion T1 described below (see FIG. 2).

The shaft member 2 is formed of a metal material, such as stainless steel, and is equipped with a shaft portion 2a, and the flange portion 2b provided at the lower end of the shaft portion 2a integrally or separately. The shaft member 2 may also be of a hybrid structure composed of a metal material and a resin material. In this case, a sheath portion including at least a press-fitting fixation surface 2a4 of the shaft portion 2a to face the hub 3 is formed of the metal, and remaining portions (e.g., the core portion of the shaft portion 2a and the flange portion 2b) are formed of resin. To secure the strength of the flange portion 2b, it is also possible to form the flange portion 2b in a hybrid structure composed of resin and metal, forming the core portion of the flange portion 2b of metal along with the sheath portion of the shaft portion 2a.

As shown in FIG. 2, in the outer periphery of the shaft portion 2a, the two radial bearing surfaces 2a1 and 2a2 opposed to the two dynamic pressure groove formation regions formed on the inner peripheral surface 8a of the sleeve portion 8 are formed so as to be axially spaced apart from each other. Above the upper radial bearing surface 2a1, there is formed adjacent thereto the tapered surface 2a3 gradually reduced in diameter toward the forward end of the shaft. Further, above the same, there is formed the press-fitting fixation surface 2a4 for the hub 3. Between the two radial bearing surfaces 2a1 and 2a2, between the lower radial bearing surface 2a2 and the flange portion 2b, and between the tapered surface 2a3 and the press-fitting fixation surface 2a4, there are formed annular small diameter portions 2c1, 2c2, and 2c3, respectively.

On the shaft end side (side nearer to an end surface 2d) of the press-fitting fixation surface 2a4 provided at the upper end of the shaft member 2, there is formed a guide portion 10 to be used when press-fitting the hub 3 onto the press-fitting fixation surface 2a4. The guide portion 10 has a cylindrical surface 11 of a smaller diameter than the inner peripheral surface 3b of the hub 3. The cylindrical surface 11 is coaxial with the press-fitting fixation surface 2a4, and its axis substantially coincides with the rotation axis of the shaft member 2.

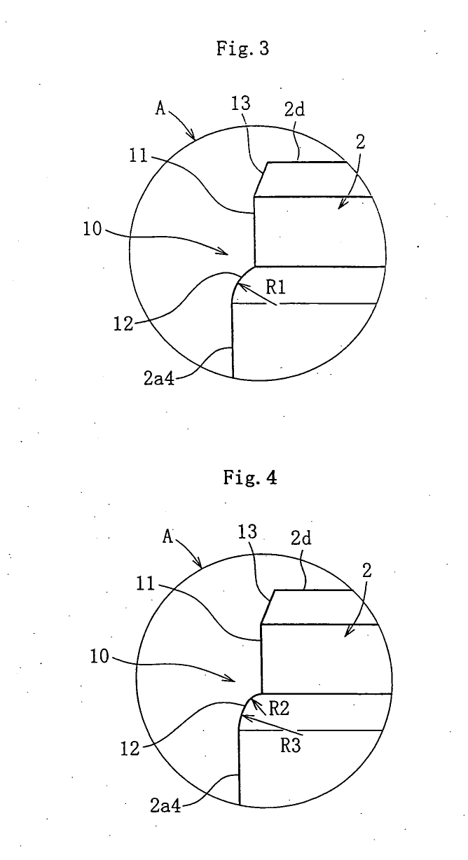

As shown, for example, in FIG. 3, between the press-fitting fixation surface 2a4 and the cylindrical surface 11, there is formed a first diverging surface 12 gradually diverging from the cylindrical surface 11 side toward the press-fitting fixation surface 2a4 side. In this embodiment, the first diverging surface 12 has an arcuate section with a diameter R1, and is smoothly continuous with the press-fitting fixation surface 2a4 situated at the lower end of the first diverging surface 12.

In the portion of the guide portion 10 between the cylindrical surface 11 and the end surface 2d, there is formed a second diverging surface 13 gradually diverging toward the cylindrical surface 11. In this embodiment, the second diverging surface 13 is formed as a tapered surface with an inclination angle of, for example, 5° to 35°, and is smoothly continuous with the cylindrical surface 11 situated at the lower end of the second diverging surface 13.

The shaft member 2 of the configuration as described above is formed by being roughly shaped by, for example, forging or turning, and then performing grinding on predetermined surfaces (for example, the cylindrical surface 11 and the press-fitting fixation surface 2a4 constituting the guide portion 10, or the radial bearing surfaces 2a1 and 2a2).

The cover member 9 sealing the lower end side of the housing portion 7 is formed of a metal material or a resin material, and is fixed to an inner periphery of the lower end of the housing portion 7 by using the above-mentioned fixing means, with the shaft member 2 being inserted into the inner periphery of the sleeve portion 8. Although not shown, all over an upper end surface 9a of the cover member 9 or in a part of an annular region thereof, there is formed, for example, a region in which a plurality of dynamic pressure grooves are arranged in a spiral form as the thrust dynamic pressure generating portion. This dynamic pressure groove formation region is opposed as the second thrust bearing surface to a lower end surface 2b2 of the flange portion 2b, and during rotation of the shaft member 2, forms between itself and the lower end surface 2b2 the thrust bearing gap of the second thrust bearing portion T2 (see FIG. 2).

After the completion of the assembly of the fluid bearing device 1, the hub 3 is press-fitted and fixed to the shaft member 2, and the housing portion 7 is fixed to the bracket 6 by adhesion, whereby the assembly of the fluid bearing device 1 to the motor is effected. At the time of press-fitting the hub 3, the cylindrical surface 11 provided in the guide portion 10 on the shaft end side of the press-fitting fixation surface 2a4 of the shaft member 2 functions as a coaxial guide surface at the time of press-fitting. As a result, the insertion attitude (forcing-in attitude) of the hub 3 is rectified, and it is possible to effect press-fitting, with the inner peripheral surface 3b of the hub 3 being coaxial with the press-fitting fixation surface 2a4. Thus, by finishing the perpendicularity of the disk mounting surface 3a with respect to the inner peripheral surface 3b of the hub 3 with high precision, the hub 3 is press-fitted and fixed to the shaft member 2 with their axes aligned with each other, thereby making it possible to achieve a satisfactory perpendicularity between the rotation axis of the shaft member 2 and the disk mounting surface 3a.

Further, due to the first diverging surface 12 with an arcuate section (rounded configuration) provided between the press-fitting fixation surface 2a4 and the cylindrical surface 11, the resistance when press-fitting the hub 3 onto the press-fitting fixation surface 2a4 is reduced, making it possible to smoothly guide the press-fitting of the hub 3 onto the press-fitting fixation surface 2a4. Thus, it is possible to reliably press-fit and fix the hub 3 while maintaining the high coaxiality obtained by the cylindrical surface 11.

Further, due to the second diverging surface 13 provided between the cylindrical surface 11 and the end surface 2d and gradually diverging from the end surface 2d side toward the cylindrical surface 11 side, fitting positioning is effected on the hub 3, making it possible to fit the hub 3 smoothly onto the cylindrical surface 11.

In the fluid bearing device 1, constructed as described above, during rotation of the shaft member 2, the dynamic pressure groove formation regions of the inner peripheral surface 8a of the sleeve portion 8 are opposed to the radial bearing surfaces 2a1 and 2a2 of the shaft member 2 through the intermediation of the radial bearing gaps. As the shaft member 2 rotates, the lubricating oil in the radial bearing gaps is forced to be fed in toward the axial center of the dynamic pressure grooves, and its pressure increases. In this way, by the dynamic pressure action of the lubricating oil generated by the dynamic pressure grooves 2a1 and 2a2, there are formed the first radial bearing portion R1 and the second radial bearing portion R2 supporting the shaft member 2 in the radial direction in a non-contact fashion (see FIG. 2).

At the same time, the pressure of the lubricating oil film formed in the thrust bearing gap between the first thrust bearing surface (dynamic pressure groove formation region) formed on the lower end surface 8b of the sleeve portion 8 and the upper end surface 2b1 of the flange portion 2b opposed thereto, and of the lubricating oil film formed in the thrust bearing gap between the second thrust bearing surface (dynamic pressure groove formation region) formed on the upper end surface 9a of the cover member 9 and the lower end surface 2b2 of the flange portion 2b opposed thereto, is enhanced by the dynamic pressure action of the dynamic pressure grooves. By the pressure of those oil films, there are formed the first thrust bearing portion T1 and the second thrust bearing portion T2 supporting the shaft member 2 in the thrust direction in a non-contact fashion.

The present invention is not restricted to the first embodiment described above, but allows adoption of another construction. In the following, another construction example of the fluid bearing device will be described. In the figures referred to below, portions and components that are of the same construction and effect as those of the first embodiment are indicated by the same reference symbols, and a redundant description thereof will be omitted.

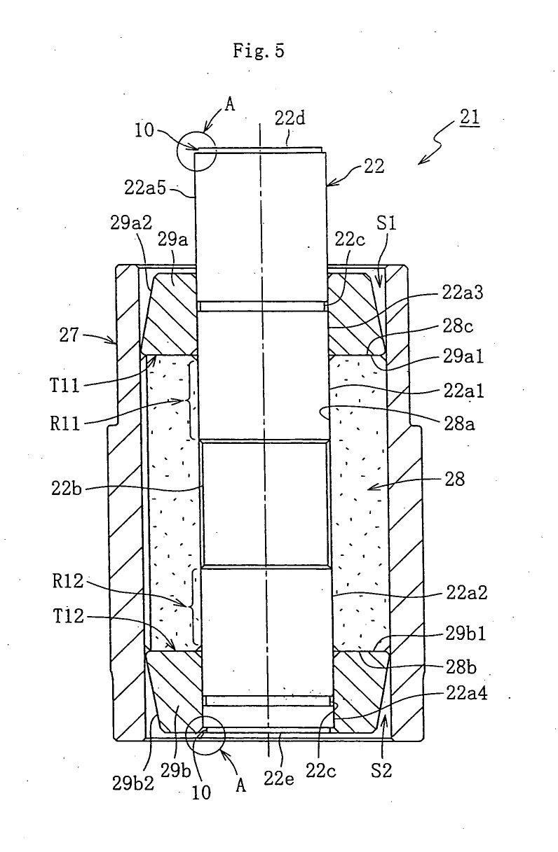

FIG. 5 shows a fluid bearing device 21 according to a second embodiment of the present invention. The fluid bearing device 21 is also incorporated for use into the spindle motor shown in FIG. 1 for a disk drive device, such as an HDD, and forms a motor with, for example, the hub 3, the stator coil 4, the rotor magnet 5, and the bracket 6 shown in FIG. 1. The fluid bearing device 21 is equipped with a housing portion 27, a sleeve portion 28 fixed to an inner periphery of the housing portion 27, a shaft member 22 adapted to make a relative rotation with respect to the housing portion 27 and the sleeve portion 28, and two seal portions 29a and 29b fixed to the shaft member 22 so as to be spaced apart from each other and defining seal spaces S1 and S2 at axial ends of the housing portion 27. In the following description of this embodiment, a side where a press-fitting fixation surface 22a5 of the shaft member 22 protrudes from the fluid bearing device 21 will be referred to as an upper side, and a side opposite to the side where the shaft member 22 protrudes will be referred to as a lower side.

The housing portion 27 is formed as a cylinder open at both ends, and is formed, for example, of a metal material or a resin material. The inner peripheral surface 27a of the housing portion 27 is formed as a cylindrical surface extending straight in the axial direction with a fixed diameter, and the sleeve portion. 28 is fixed to a middle portion in the axial direction of the inner peripheral surface 27a by means, such as adhesion, press-fitting, or welding.

Unlike the sleeve 8 according to the first embodiment of the present invention, although not shown, the sleeve portion 28 is equipped with dynamic pressure groove arrangement regions as thrust dynamic pressure generating portions provided all over or in a part of annular regions of a lower end surface 28b and an upper end surface 28c thereof. Those dynamic pressure groove formation regions are opposed to a lower end surface 29a1 of the first seal portion 29a (upper side) fixed to the shaft member 22 and an upper end surface 29b of the second seal portion 29b (lower side), respectively. During rotation of the shaft member 22, there are formed, between these regions and the lower end surface 29a1 of the first seal portion 29a and the upper end surface 29b1 of the second seal portion 29b, the thrust bearing gaps of a first thrust bearing portion T11 and a second thrust bearing portion T12 (see FIG. 5).

The shaft member 22 is formed of a metal material, such as stainless steel, or in a hybrid structure of metal and a resin (e.g., one whose sheath portion is metal and whose core portion is a resin). As a whole, the shaft member 22 is formed as a shaft of the same diameter, and has in the middle portion thereof a clearance portion 22b whose diameter is slightly smaller than that of the remaining portion. In fixation regions 22a3 and 22a4 of the first and second seal portions 29a and 29b formed in the outer periphery of the shaft portion 22, there are formed recesses, for example, circumferential grooves 22c.

As shown in FIG. 5, in the outer periphery of the shaft member 22, there are formed two axially separated radial bearing surfaces 22a1 and 22a2 opposed to two dynamic pressure groove formation regions (not shown) formed on an inner peripheral surface 28a of the sleeve portion 28. Above the upper radial bearing surface 22a1, there is formed the fixation region 22a3 of the first seal portion 29a so as to be continuous with the radial bearing surface 22a1. Further, above the fixation region 22a3, there is formed the press-fitting fixation surface 22a5 for the hub 3. Below the lower radial bearing surface 22a2, there is formed the fixation region 22a4 of the second seal portion 29b so as to be continuous with the radial bearing surface 22a2. In this embodiment, the second seal portion 29b is press-fitted and fixed to the lower end of the shaft member 22, so the press-fitting fixation region 22a4 constitutes the press-fitting fixation surface for the second seal portion 29b (Hereinafter, uniformly referred to as press-fitting fixation surface 22a4).

Between the press-fitting fixation surface 22a5 for the hub 3 provided at the upper end of the shaft member 22 and the end surface 22d, there is provided the guide portion 10 to be used when press-fitting the hub 3 onto the press-fitting fixation surface 22a5. As in the case of FIG. 3, the cylindrical surface 11, the first diverging surface 12, and the second diverging surface 13 are formed in the guide portion 10. Similarly, a guide portion 10 is provided between the press-fitting fixation surface 22a4 for the second seal portion 29b provided at the lower end of the shaft member 22 and the end surface 22e, and this guide portion 10 also has a cylindrical surface 11, a first diverging surface 12, and a second diverging surface 13 similar to those of FIG. 3.

As in the case of the first embodiment, the shaft member 22 of the above configuration is formed roughly shaping by, for example, forging or turning, and then performing grinding on a predetermined surface thereof.

The first seal portion 29a and the second seal portion 29b are both formed in an annular configuration of a metal material, such as brass, or a resin material. An operation of fixing the seal portions 29a and 29b to the shaft member 22 is effected, for example, by the following steps. First, the second seal portion 29b is press-fitted and fixed to the press-fitting fixation surface 22a4 provided at the lower end of the shaft member 22. In this process, due to the guide portion 10 provided between the press-fitting fixation surface 22a4 and the end surface 22e, that is, the cylindrical surface 11, the first diverging surface 12, and the second diverging surface 13 (see FIG. 3), the press-fitting of the second seal portion 29b onto the press-fitting fixation surface 22a4 is effected smoothly while maintaining a high level of coaxiality with respect to the shaft member 22.

In the state in which the second seal portion 29b has been thus fixed to the shaft member 22, the first seal portion 29a is fixed to the fixation region 22a3 of the shaft member 22 by means, such as adhesion or press-fitting (inclusive of press-fitting/adhesion). In this process, the first seal portion 29a is fixed by using, for example, the upper end surface 29b1 of the previously fixed second seal portion 29b (or the end surface of the shaft member 22) as a reference, so the first seal portion 29a is fixed to the shaft member 22 while maintaining a high level of coaxiality with respect to the shaft member 22 or a satisfactory perpendicularity of the lower end surface 29a1 with respect to the shaft member 22. In this embodiment, the circumferential grooves 22c are respectively provided in the fixation regions 22a3 and 22a4 of the seal portions 29a and 29b, respectively, so when fixing the seal portions 29a and 29b by using adhesive, the circumferential grooves 22c serve as adhesive gathering portions, whereby the adhesion strength (fixation strength) of the seal portions 29a and 29b with respect to the shaft member 22 is enhanced.

After completion of the assembly of the above fluid bearing device 21, the hub 3 is press-fitted and fixed to the shaft member 22, and the housing portion 27 is fixed to the bracket 6 by adhesion, whereby the assembly of the fluid bearing device 21 to the motor is effected. In this embodiment also, there is provided, between the press-fitting fixation surface 22a5 of the shaft member 22 and the end surface 22d, the guide portion 10, that is, the cylindrical surface 11, the first diverging surface 12, and the second diverging surface 13, so it is possible to press-fit the hub 3 onto the shaft member 22 smoothly while maintaining a high level of coaxiality with respect to the shaft member 22. Thus, it is possible to fix the hub 3 to the shaft member 22 while maintaining a satisfactory perpendicularity for the disk mounting surface 3a with respect to the shaft member 22, making it possible to suppress as much as possible the run-out of the disk D during use of the motor and to perform writing to or reading from the disk D with high accuracy.

In the fluid bearing device 21, constructed as described above, during rotation of the shaft member 22, the dynamic pressure groove formation regions of the inner peripheral surface 28a of the sleeve portion 28 are opposed to the radial bearing surfaces 22a1 and 22a2 of the shaft member 22 through the intermediation of the radial bearing gaps. As the shaft member 22 rotates, the lubricating oil in the radial bearing gaps is forced to be fed in toward the axial centers of the dynamic pressure grooves, and its pressure increases. In this way, by the dynamic pressure action of the lubricating oil generated by the dynamic pressure grooves, there are formed a first radial bearing portion R11 and a second radial bearing portion R12 supporting the shaft member 22 in the radial direction in a non-contact fashion (see FIG. 5).

At the same time, the pressure of the lubricating oil film formed in the thrust bearing gap between the first thrust bearing surface (dynamic pressure groove formation region) formed on the upper end surface 28c of the sleeve portion 28 and the lower end surface 29a1 of the first seal portion 29a opposed thereto, and of the lubricating oil film formed in the thrust bearing gap between the second thrust bearing surface (dynamic pressure groove formation region) formed on the lower end surface 28b of the sleeve portion 28 and the upper end surface 29b1 of the second seal portion 29b opposed thereto, is enhanced by the dynamic pressure action of the dynamic pressure grooves. Due to the pressure of those oil films, there are formed a first thrust bearing portion T11 and a second thrust bearing portion T12 supporting the shaft member 22 in the thrust direction in a non-contact fashion.

Further, in the fluid bearing device 21 of the second embodiment, seal spaces S1 and S2 are formed at the axial ends of the fluid bearing device 21, more specifically, between the outer peripheral surface 29a2 of the first seal portion 29a fixed to the shaft member 22 and the upper end portion of the inner peripheral surface 27a of the housing portion 27 opposed thereto, and between the outer peripheral surface 29b2 of the second seal portion 29b and the lower end portion of the inner peripheral surface 27a opposed thereto, respectively.

The seal spaces S1 and S2 are formed between the outer peripheral surfaces 29a2 and 29b2 of the seal portions 29a and 29b protruding outwardly from the shaft member 22 and the inner peripheral surface 27a of the housing portion 27. Thus, as compared with the case in which the seal space is formed between the seal portion fixed to the housing portion and the outer peripheral surface of the shaft member (see, for example, JP 2003-239951 A), the seal space can be formed more outwardly, thereby making it possible to secure the requisite volume of the seal space while achieving a reduction in the axial thickness of the seal portions 29a and 29b. Thus, it is possible, for example, to make an axial dimension of the sleeve portion 28 smaller than in the prior art or to make the axial dimension of the sleeve portion 28 larger than in the prior art to thereby increase an axial distance between the dynamic pressure groove formation region of the first radial bearing portion R11 and the dynamic pressure groove formation region of the second radial bearing portion R12. In the former case, it is possible to make an axial dimension of the fluid bearing device smaller than in the prior art, while, in the latter case, it is possible to enhance the load capacity with respect to the moment load. Further, it is possible to form the shaft member 22 in a substantially straight configuration with a fixed outer diameter, so it is possible, for example, to omit the machining for achieving perpendicularity of the shaft member 2 with respect to the flange portion 2b, thereby achieving a reduction in machining cost.

While the first and second embodiments are described above, the present invention is also applicable to a fluid bearing device of a construction other than those of the first and second embodiments described above as long as it is a fluid bearing device equipped with at least a shaft member to one end of which another member is press-fitted and fixed. When a fluid bearing device according to the present invention is incorporated into motors for other uses, such as a polygon scanner motor or a fan motor, the turntable of the polygon scanner motor corresponds to the other member to be press-fitted and fixed to the shaft member. Or, the fan of the fan motor corresponds to the other member.

While in the above-described embodiments (first and second embodiments) described above the housing portion 7, 27 and the sleeve portion 28 are formed separately, and then one component is fixed to the other component, it is also possible to form them as an integral unit of metal or resin.

Further, while in the above embodiments the hub 3 and the seal portions 29a, 29b are used as the member press-fitted and fixed to the shaft member 2, 22, when, for example, the flange portion 2b in the first embodiment is separate from the shaft member 2 (i.e., the shaft portion 2a thereof), the flange portion 2b may be the member to be press-fitted and fixed to the shaft member 2.

Further, while in the above-described embodiments the first diverging surface 12 has an arcuate section, it is not always necessary for the first diverging surface 12 to have an arcuate section. Any sectional configuration will do as long as it allows smooth movement (press-fitting) of the hub 3, etc. to the press-fitting fixation surface 2a4. For example, it is also possible to form the first diverging surface 12 as a tapered surface. In this case, it is desirable for the inclination of the first diverging surface 12 formed as a tapered surface to be not more than 10°. Further, the second diverging surface 13 is not restricted to a tapered surface, either. It may also be an arcuate surface like the first diverging surface 12 shown in FIG. 3. Alternatively, the first and second diverging surfaces 12 and 13 may be formed in a configuration other than a unitary tapered surface and a unitary arcuate surface. For example, in the guide portion 10 shown in FIG. 4, the first diverging surface 12 is composed of arcuate surfaces of different radii (radius R2 and radius R3). In this way, it is possible to form the first and second diverging surfaces 12 and 13 through a combination of arcuate surfaces of different diameters or a combination of tapered surfaces of different inclination angles, or further, a combination of two or more of such arcuate surfaces and tapered surfaces.

Further, while in the above-described embodiments the dynamic pressure generating portions such as dynamic pressure grooves are on the inner peripheral surface 8a, 28a, the lower end surface 8b, 28b, and the upper end surface 28c of the sleeve portion 8, 28, and on the upper end surface 9a of the cover member 9, this should not be construed restrictively. It is also possible to form the dynamic pressure generating portions on the radial bearing surface 2a1, 22a1 of the shaft member 2, 22 opposed thereto, the end surfaces 2b1 and 2b2 of the flange portion 2b, or the lower end surface 29a1 of the first seal portion 29a and the upper end surface 29b1 of the second seal portion 29b. The dynamic pressure generating portions of the mode described below may also be formed on the opposing shaft member 2 side.

Further, while in the above embodiments the dynamic pressure action of a lubricating fluid is generated by herringbone-shaped or spiral dynamic pressure grooves formed in the radial bearing portions R1 and R2 (R11 and R12) and the thrust bearing portions T1 and T2 (T11 and T12), the D-resent invention is not restricted to this construction.

For example, although not shown, it is also possible to adopt, as the radial bearing portions R1 and R2, so-called step-like dynamic pressure generating portions in which a plurality of axial grooves are arranged circumferentially, or so-called multi-arc bearings in which a plurality of arcuate surfaces are arranged circumferentially and in which wedge-like radial gaps (bearing gaps) are formed between the arcuate surfaces and the outer peripheral surfaces (radial bearing surfaces 2a1 and 2a2) of the opposing shaft member 2.

Alternatively, it is also possible to form the inner peripheral surface 8a of the sleeve 8 as a cylindrical inner peripheral surface provided with no dynamic pressure grooves, arcuate surfaces, etc. as dynamic pressure generating portions, and to form a so-called cylindrical bearing together with the cylindrical outer peripheral surface (radial bearing surfaces 2a1 and 2a2) of the shaft member 2 opposed to this inner peripheral surface.

Further, although not shown, one or both of the thrust bearing portions T1 and T2 may be formed as so-called step bearings or corrugated bearings (corrugated step bearings) or the like in which there are provided in regions constituting the thrust bearing surfaces a plurality of groove-shaped radial dynamic pressure grooves at predetermined circumferential intervals.

Further, apart from the construction in which the shaft member 2 is supported in a non-contact fashion by the dynamic pressure action of dynamic pressure grooves, the thrust bearings T1 and T2 may also be formed, for example, as so-called pivot bearings in which the end portions of the shaft member 2 are formed in a spherical configuration, with contact support being effected between the spherical ends and the thrust bearing surfaces opposed thereto.

Further, while in the first and second embodiments a lubricating oil is used as the fluid filling the interior of the fluid bearing device 1, 21 and forming lubricant films in the radial bearing gaps and the thrust bearing gaps, it is also possible to use some other fluid capable of generating dynamic pressure action in the bearing gaps, for example, a gas, such as air, a lubricant with fluidity, such as a magnetic fluid, or a lubricating grease.

1. A fluid bearing device comprising:
a shaft member to which another member is press-fitted and fixed;
a radial bearing gap formed between an outer peripheral surface of the shaft member and a surface opposed to the outer peripheral surface of the shaft member, a lubricant film of a fluid generated in the radial bearing gap supporting the shaft member in a manner which allows relative rotation;
a press-fitting fixation surface formed at least one end of the shaft member; and
a guide portion to be used when press-fitting the other member onto the press-fitting fixation surface provided between the press-fitting fixation surface and a shaft end surface,
wherein the guide portion has a cylindrical surface having a smaller diameter than an inner peripheral surface of the other member.

2. A fluid bearing device according to claim 1, wherein the guide portion has between the press-fitting fixation surface and the cylindrical surface a first diverging surface gradually diverging from the cylindrical surface toward the press-fitting fixation surface.

3. A fluid bearing device according to claim 2, wherein the guide portion has between the cylindrical surface and the shaft end surface a second diverging surface gradually diverging from the shaft end surface toward the cylindrical surface.

4. A fluid bearing device according to claim 1, wherein at least the press-fitting fixation surface and the cylindrical surface are formed by grinding.

5. A fluid bearing device according to claim 1, wherein a hub constituting the other member is press-fitted and fixed to one end of the shaft member.

6. A fluid bearing device according to claim 1, further comprising a seal portion press-fitted and fixed to another end of the shaft member.

7. A fluid bearing device according to claim 5, further comprising a seal portion press-fitted and fixed to another end of the shaft member.
